(19) United States
(12) Patent Application Publication
(10) Pub. No.: US 2026/0129617 A1
(43) Pub. Date: May 7, 2026

(54) MOBILE TERMINATED EARLY DATA TRANSMISSION FOR INTERNET OF THINGS

(71) Applicant: Nokia Technologies Oy, Espoo (FI)

(72) Inventors: Srinivasan SELVAGANAPATHY, Bangalore (IN); Mads LAURIDSEN, Aalborg (DK); Jeroen WIGARD, Aalborg (DK); Ping YUAN, Beijing (CN); Xiang XU, Beijing (CN)

(21) Appl. No.: 19/114,716

(22) PCT Filed: Sep. 27, 2022
(86) PCT No.: PCT/CN2022/121864

§ 371 Date: Mar. 24, 2025

(51) Int. Cl. H04W 68/02; H04W 12/065; H04W 74/0833

(52) U.S. Cl. CPC H04W 68/02; H04W 12/065; H04W 74/0833

(57) ABSTRACT

Embodiments of the present disclosure relate to devices, methods, apparatuses and computer readable storage media of Mobile Terminated Early Data Transmission (MT-EDT) for Internet of Things (IoT). The method comprises in response to detecting, at a first device, a paging from a second device for a MT-EDT, sending, to the second device, a paging response at least comprising authentication information negotiated between the first device and a third device for a verification at the second device; and receiving data transmission from the second device. In this way, the performance and efficiency of the MT-EDT in the S&F mode can be improved significantly.

### FIELD

Embodiments of the present disclosure generally relate to the field of telecommunication and in particular to devices, methods, apparatuses and computer readable storage media of Mobile Terminated Early Data Transmission (MT-EDT) for Internet of Things (IoT).

### BACKGROUND

The Third Generation Partnership Project (3GPP) has initiated a study item on the support of the Narrow Band Internet of Things (NB-IoT), especially for a Non-Terrestrial Networks (NTN) scenario. It is to be expected that this study item will be further developed.

### SUMMARY

In general, example embodiments of the present disclosure provide a solution of MT-EDT for IoT.

In a first aspect, there is provided a first device. The first device comprises at least one processor; and at least one memory storing instructions that, when executed by the at least one processor, cause the first device at least to in response to detecting, from a second device, a paging for a MT-EDT, send, to the second device, a paging response at least comprising authentication information negotiated between the first device and a third device for a verification at the second device; and receive data transmission from the second device.

In a second aspect, there is provided a second device. The second device comprises at least one processor; and at least one memory storing instructions that, when executed by the at least one processor, cause the second device at least to initiate a paging procedure for a MT-EDT; in response to receiving, from a first device, a paging response at least comprising authentication information, verify a validity of the paging response based on expected paging response related information for the MT-EDT received from a third device; and in response to determining that the paging response is valid, perform the data transmission to the first device.

In a third aspect, there is provided a third device. The third device comprises at least one processor; and at least one memory storing instructions that, when executed by the at least one processor, cause the third device at least to generate expected paging response related information based on a paging response for a MT-EDT at least comprising authentication information negotiated between a first device and the third device for a verification at a second device.

In a fourth aspect, there is provide a method. The method comprises in response to detecting, at a first device and from a second device, a paging for a MT-EDT, sending, to the second device, a paging response at least comprising authentication information negotiated between the first device and a third device for a verification at the second device; and receiving data transmission from the second device.

In a fifth aspect, there is provide a method. The method comprises initiating, from a second device, a paging procedure for a MT-EDT; in response to receiving, from a first device, a paging response at least comprising authentication information, verifying a validity of the paging response based on expected paging response related information for the MT-EDT received from a third device; and in response to determining that the paging response is valid, performing the data transmission to the first device.

In a sixth aspect, there is provide a method. The method comprises generating, at a third device, expected paging response related information based on a paging response for a MT-EDT at least comprising authentication information negotiated between a first device and the third device for a verification at a second device.

In a seventh aspect, there is provided an apparatus comprising means for, in response to detecting, from a second device, a paging for a MT-EDT, sending, to the second device, a paging response at least comprising authentication information negotiated between the first device and a third device for a verification at the second device; and means for receiving data transmission from the second device.

In an eighth aspect, there is provided an apparatus comprising means for initiating a paging procedure for a MT-EDT; means for, in response to receiving, from a first device, a paging response at least comprising authentication information, verifying a validity of the paging response based on expected paging response related information for the MT-EDT received from a third device; and means for, in response to determining that the paging response is valid, performing the data transmission to the first device.

In a ninth aspect, there is provided an apparatus comprising means for generating expected paging response related information based on a paging response for a MT-EDT at least comprising authentication information negotiated between a first device and the third device for a verification at a second device.

In a tenth aspect, there is provided a computer readable medium having a computer program stored thereon which, when executed by at least one processor of a device, causes the device to carry out the method according to the fifth aspect, the sixth aspect or the seventh aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example environment in which example embodiments of the present disclosure may be implemented;

FIG. 2 shows a signaling chart illustrating a process of MT-EDT for IoT according to some example embodiments of the present disclosure;

FIG. 3 shows a flowchart of an example method of MT-EDT for IoT according to some example embodiments of the present disclosure;

FIG. 4 shows a flowchart of an example method of MT-EDT for IoT according to some example embodiments of the present disclosure;

FIG. 5 shows a flowchart of an example method of MT-EDT for IoT according to some example embodiments of the present disclosure;

FIG. 6 shows a simplified block diagram of a device that is suitable for implementing example embodiments of the present disclosure; and

FIG. 7 shows a block diagram of an example computer readable medium in accordance with some embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT), an Enhanced Machinetype communication (eMTC) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the terms “network device”, “radio network device” and/or “radio access network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture includes a Centralized Unit (CU) and a Distributed Unit (DU). In some other example embodiments, part of the radio access network device or full of the radio access network device may embarked on an airborne or space-borne NTN vehicle.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

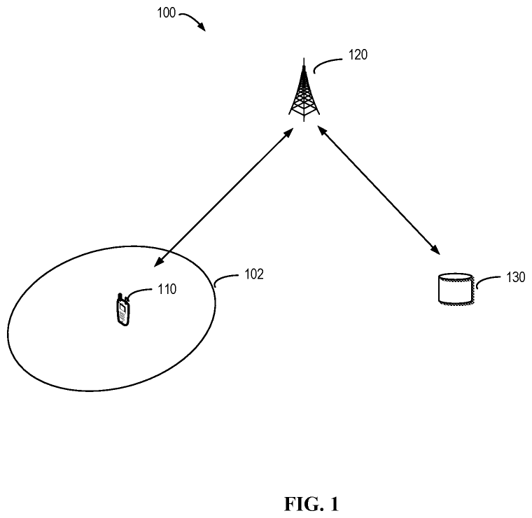

FIG. 1 shows an example communication network 100 in which embodiments of the present disclosure can be implemented. As shown in FIG. 1, the communication network 100 may comprise a terminal device 110. Hereinafter the terminal device 110 may also be referred to as a UE 110 or a first device 110. For example, the terminal device may be implemented as a IoT device in the communication network 100.

The communication network 100 may further comprise a Radio Access Network (RAN) device 120. Hereinafter the RAN device 120 may also be referred to as a network device, a BS, a gNB, an eNB or a second device 120. The terminal device 110 may communicate with the RAN device 120 within a coverage of a cell 102 managed by the RAN device 120.

Furthermore, the communication network 100 may also comprise a Core Network (CN) device 130. Hereinafter the CN device 130 may also be referred to as a third device 130. The CN device 130 may serve the terminal devices, for example 110 communicated with the RAN device 120.

In some scenarios, the communication network 100 may refer to an NTN and the RAN device 120 may be implemented in a satellite and moves along with the satellite. In some other scenarios, the communication network 100 may also refer to any other suitable networks.

It is to be understood that the number of network devices and terminal devices shown in FIG. 1 is given for the purpose of illustration without suggesting any limitations. The communication network 100 may include any suitable number of network devices and terminal devices.

Communications in the communication environment 100 may be implemented according to any proper communication protocol(s), includes, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, includes but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

There is a new scenario “Store-and-forward (S&F)” for IoT NTN. The S&F may allow a satellite to provide service to IoT NTN devices even in periods/areas when/where the satellite is not connected to a CN device, e.g., Gateway (GW) or any other CN device or node, on the ground. A RAN device on board architecture and a non-simultaneous operation of the service link and the feeder link are assumed. The messages may be stored on board until there is line of sight with the GW.

The S&F operation may refer to a discontinuous coverage scenario, where the UE may only occasionally and temporarily have coverage from a satellite. It is also possible that the discontinuous coverage scenario may be expanded with defining that the satellite is not always connected with the CN device. Hereinafter the RAN device may be referred to as an eNB, a gNB or any other suitable RAN devices.

For example, in the example communication network 100 as shown in FIG. 1, the RAN device 120 may not connect with UE 110 and CN device 130 all the time or at the same time. If the RAN device 120 may provide a cell 102 for serving the UE 110 as the satellite moves, the UE 110 may connect with the RAN device 120, while if the RAN device 120 may connect to the CN 130, the CN 130 may connect with the RAN device 120. That is, possibility of UE connectivity and GW connectivity may be at different time instances.

NTN connectivity for cellular IoT is one of the main usage situations for NTN based cellular IoT. In these scenarios, the nature of IoT data traffic and also available features in terrestrial IoT features plays important role in defining solution for IoT-NTN in S&F mode in discontinuous coverage scenarios.

For example, the IoT data traffic may refer to small data transmission with few packets of transmission mostly and the application acknowledge (ACK) is optional. Furthermore, periodic data transmissions may not be time critical for the IoT data traffic and emergency transmissions (exception reports) may need to reach the application within certain duration.

Some IoT features are defined for enhancing NTN connectivity with discontinuous coverage in S&F mode, for example, an EDT mechanism has been proposed. In EDT, a single user packet may be transmitted during random access procedure. No Radio Resource Control (RRC) connection is established for the EDT.

For MT-EDT, the RAN device may need to trigger paging procedure for the EDT. If the UE initiates MO EDT procedure and sends paging response, the RAN device may obtain payload from the CN device and send it to the UE in a random-access message, for example, in Message 4. This interaction may need the RAN device/satellite have a connection with both UE and CN device.

However, in S&F mode, the RAN device/satellite may only have the connection with CN device for a period. Similarly, the RAN device/satellite have the connection with UE for a period. The RAN device/satellite may not simultaneously have both connections, i.e., with the UE, and with the CN device.

Therefore, the MT-EDT may not work well in this scenario because (1) the RAN device may not be covering the UE last connected cell based on geo-fixed cell-ID of last connection; (2) paging attempt may be fail and the CN device may not deliver the payload to the RAN device and there may not be any chance to deliver the MT-EDT data if the RAN connectivity disappears; (3) the MT-EDT may require multiple pass to deliver the MT-EDT data to the UE due to the discontinuous connection between the RAN device/satellite and the UE, and the discontinuous connection between the RAN device/satellite and the CN device; (4) the RAN node cannot ask the CN to verify the UE, because RAN is only connected with UE at this point in time.

According to some example embodiments of the present disclosure, there is provided a solution for MT-EDT for IoT. In this solution, the UE negotiates with the CN device content of the paging response for a further paging for MT-EDT. The CN device may provide the content of the paging response to the RAN device. If a paging procedure is triggered from the RAN device and the UE detects the paging, the UE may send the negotiated paging response to the RAN device. If the RAN device verifies the paging response is valid, the RAN device sends the downlink data to the UE. In this way, the performance and efficiency of the MT-EDT in the S&F mode can be improved significantly.

It is to be understood that the CN device may referred to as a NCE/MME/SGW/UDM/PCF/AMM/SMF/LMF/LMC, which can comprise a network control element (NCE), and/or serving gateway (SGW), and/or MME (Mobility Management Entity) and/or SGW (Serving Gateway) functionality, and/or user data management functionality (UDM), and/or PCF (Policy Control) functionality, and/or Access and Mobility (AMF) functionality, and/or Session Management (SMF) functionality, Location Management Function (LMF), Location Management Component (LMC) and/or Authentication Server (AUSF) functionality and which provides connectivity with a further network, such as a telephone network and/or a data communications network (e.g., the Internet), and which is configured to perform any 5G and/or NR operations in addition to or instead of other standards operations at the time of this application. The NCE/MME/SGW/UDM/PCF/AMM/SMF/LMF/LMC is configurable to perform operations in accordance with example embodiments of the invention in any of an LTE, NR, 5G and/or any standards-based communication technologies being performed or discussed at the time of this application.

Example embodiments of the present disclosure will be described in detail below with reference to the accompanying drawings.

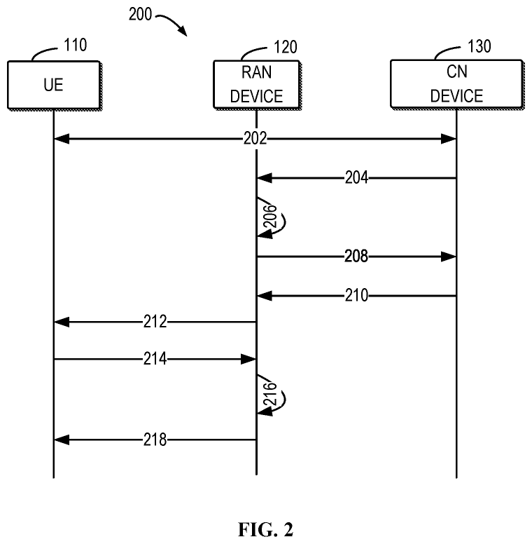

Reference is now made to FIG. 2, which shows a signaling chart 200 for communication according to some example embodiments of the present disclosure. As shown in FIG. 2, the signaling chart 200 involves a UE 110, a RAN device 120 and a CN device 130. For the purpose of discussion, reference is made to FIG. 1 to describe the signaling chart 200. Although a single UE 110 and a single RAN device 120 are illustrated in FIG. 2, it would be appreciated that there may be a plurality of UEs and a plurality of RAN devices performing similar operations as described with respect to the UE 110 and the RAN 120 below, respectively.

As shown in FIG. 2, for supporting the MT-EDT in S&F mode (or S&F MT-EDT), the UE 110 may exchange the capability to support S&F MT-EDT with the CN device 130 and negotiate 202 with the CN 130 content of a paging response for a further paging procedure initiated for the MT-EDT. Hereinafter the term EDT may also refer to a SDT.

For example, the UE 110 may negotiate with the CN device 130 an authentication information for the paging response. For example, the authentication information may be a security token. It is to be understood that other suitable authentication information may also be used.

In some embodiments, the UE 110 may negotiate with the CN device 130 different paging responses for a plurality of further successive MT-EDTs. The fields included in the respective contents of paging responses may be changed in order, e.g., incrementally across the plurality of successive MT-EDTs. In this way, the use of a static paging response across multiple EDTs can be avoided. That is, for every new MT-EDT paging attempts, the UE 110 may adopt a different paging response.

It is to be understood that the negotiated paging response are pre-agreed between the UE 110 and the CN device 130. It is also possible that the negotiated paging response may be renegotiated or configured by the CN device 130.

If the RAN device 120 connects to the CN device 130, the CN device 130 may send 204 a paging message for MT-EDT to the RAN device 120 along with other related information such as last connected cell information and/or the number of packets.

In some scenarios, the RAN 120 may determine 206 that the RAN 120 does not serve the UE 110 (in the lasted connected cell) currently but may deliver MT-EDT to the UE 110 later. For example, the RAN 120 moves along the predetermined orbit of the satellite and the RAN device 120 may know that it may move to the cell serving the UE 110 later.

In this situation, the RAN device 120 may send 208, to the CN device 130, a request of information associated with the MT-EDT. The request may be sent from the RAN device 120 to CN device 130 via S1 message, which may be represented with a field called “Get-DL-Data-for-late-forwarding” or “SI-DL-Data-Request-SF”, for example. This request may comprise at least one of the number of packet to be sent in the MT-EDT, a reference cell identification or a request of the authentication information for the paging response, which may be represented with a field called “NAS-security-token-DL-Fetching”.

If the CN device 130 receives the request, the CN device 130 may provide 210, to the RAN device, a response including the information associated with the paging response, which may be referred to as expected paging response or Non-Access-Stratum (NAS) level paging response. The NAS level paging response may be sent via a control message, such as a S1 message. It is to be understood that the expected paging response used hereinafter may also be considered as a NAS paging response.

For example, the response sent from the CN device 130 to the RAN device 120 may comprise the downlink data to be sent to the UE 110 in the MT-EDT, the authentication information for the paging response, and/or a timer indicating the validity of the authentication information, which may be, for example, indicated via at least one of the following fields “DL-NAS-Transport message for SF”, “NAS-Paging-response” or “Validity-timer for UE connectivity”. As such, if the RAN device 120 obtains the NAS level paging response, the RAN device 120 may compare the paging response received from the UE 110 with the information obtained from the NAS level paging response, to verify whether the received paging response is valid assuming fixed value for fields in the paging response for MT-EDT.

The case where the RAN 120 requests the information associated with the paging response has been described above. As another option, if the CN device 130 is aware of the information that the RAN device 120 will serve the UE 110 in the future, the CN device 130 may also directly send paging and MT-EDT packet directly. For example, the CN device 130 may transmit the paging message for MT-EDT (transmitted in the action 204) along with the response including the information associated with the paging response (transmitted in the action 210) to the RAN device 120.

If the RAN device 120 detects that it starts serving the cell where the UE 110 is located, the RAN device 120 may trigger 212 a paging procedure. For example, the RAN device 120 may send a paging message, which may be a RRC message.

After detecting the paging, the UE 110 may send 214, to RAN device 120, a paging response that has been negotiated with the CN 130 by initiating a Mobile Oriented EDT (MO-EDT). In one example embodiment, the paging response may be sent as part of the RRCConnectionResumeRequest message for MO-EDT for User Plane Cellular IoT (CIoT) Evolved Packet System (EPS) Optimisations, or as part of RRCEarlyDataRequest message for MO-EDT for Control Plane CIoT 5G System (5GS) Optimisation, or any other RRC message. As another option, the UE 110 may be allowed to only send the negotiated authentication information. It is to be understood that the RAN device 120 does not have a connectivity with the UE 110 when the UE 110 receives the paging.

The RAN device 120 may verify 216 whether the paging response and/or the authentication information received from the UE 110 is valid based on the information obtained from the CN device 130. For example, the RAN device 120 may check whether the content included in the received paging response matches with that included in the information obtained from the CN device 130. Alternatively, the RAN device 120 may check whether the authentication information based on the timer of validity of authentication information. It is to be understood that the authentication information needs to be refreshed when the UE 110 moves out of the current serving cell or when the timer expires. In this case, the timer can be used to avoid the RAN 120 to push data for any UE from the CN device 130, for example, when the timer expires.

If the RAN device 120 determines that the paging response and/or the authentication information received from the UE 110 is valid, the RAN device 120 may trigger 218 the MT-EDT or a RRC connection to send the downlink data to the UE 110.

Alternatively, the MT-EDT delivery may be performed without NAS level paging response. For example, if the MT-EDT contents are short and meant for simple actions at MTC device (i.e., the UE 110), the security check on paging response may be avoided in Small Data Transmission (SDT) mode. In this case, the CN device 130 does not need to provide the ‘NAS level paging response’ for verification. The RAN device 120 may identify the binding between paging identifier and AS message based on identifier given in RRC message.

By the solution of the present invention, the MT-EDT may work well even if the RAN device may not simultaneously have both connections with the UE and the CN device. In this way, the paging failure and low transmission efficiency may be avoided and therefore the system performance and security may be guaranteed.

It is to be understood that the solution mentioned hereinafter for the EDT may also be used for a SDT.

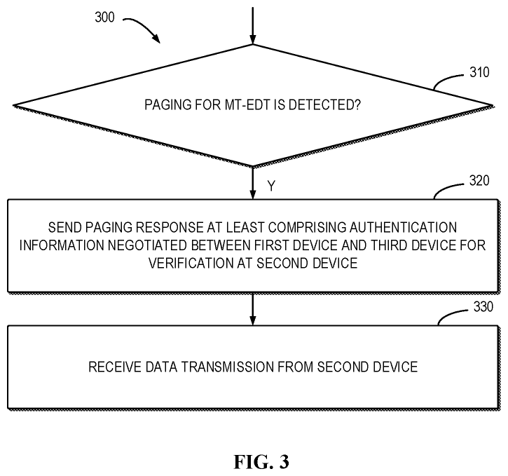

FIG. 3 shows a flowchart of an example method 300 of MT-EDT for IoT according to some example embodiments of the present disclosure. The method 300 may be implemented at the first device 110 as shown in FIG. 1. For the purpose of discussion, the method 300 will be described with reference to FIG. 1.

At 310, if the first device 110 detects a paging from a second device for a MT-EDT, the first device, at 320, sends, to the second device, a paging response at least comprising authentication information negotiated between the first device and a third device for a verification at the second device.

In some example embodiments, the paging response is sent from the first device to the second device via an MSG 3 in a random access procedure or a RRC signaling.

In some example embodiments, the first device may negotiate the paging response for the MT-EDT with the third device, the authentication information being included in the paging response.

In some example embodiments, respective paging responses with different fields are negotiated between the first device and the third device for a plurality of successive mobile terminated early data transmissions, and wherein the different fields are used for the plurality of successive mobile terminated early data transmissions in order.

At 330, the first device 110 receives data transmission from the second device.

In some example embodiments, the first device may receive the data transmission from the second device via the MT-EDT procedure or a RRC connection.

In some example embodiments, the first device comprises a terminal device, the second device comprises a radio access network device and the third device comprises a core network device. The first device, the second device and the third device operate in the store and forward mode.

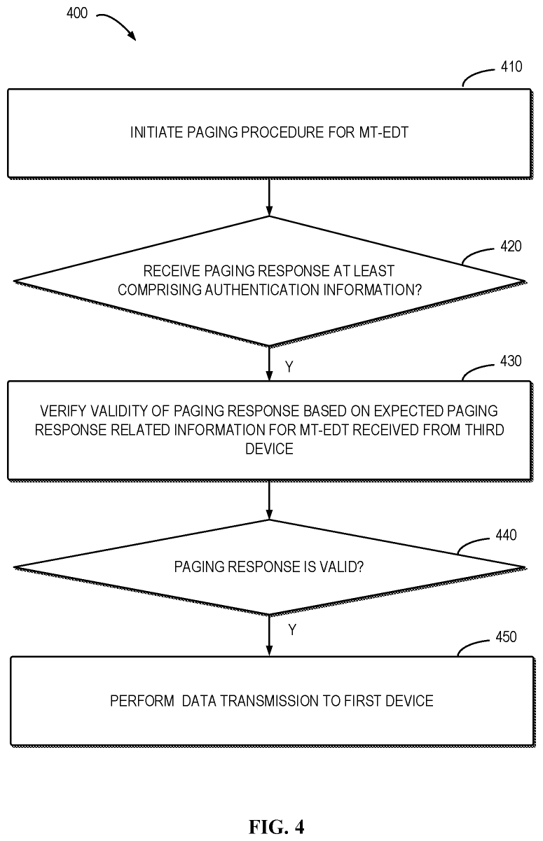

FIG. 4 shows a flowchart of an example method 400 of MT-EDT for IoT according to some example embodiments of the present disclosure. The method 400 may be implemented at the second device 120 as shown in FIG. 1. For the purpose of discussion, the method 400 will be described with reference to FIG. 1.

At 410, the second device 120 initiates a paging procedure for a MT-EDT.

At 420, if the second device 120 receives, from a first device, a paging response at least comprising authentication information, the second device, at 430, verifies a validity of the paging response based on expected paging response related information for the MT-EDT received from a third device.

In some example embodiments, the second device may verify the validity of the paging response for an authentication of the first device.

In some example embodiments, the second device may obtain, from a third device, the expected paging response related information. The expected paging response related information may comprise at least one of a downlink NAS transport message, an expected paging response, a validity timer for a connectivity of the first device, or a validity timer for a lifetime of the expected paging response.

In some example embodiments, the expected paging response related information is obtained via a control message, such as a S1 message.

In some example embodiments, if the second device receives, from the third device, an indication that the first device is to be served by the second device, the second device may send, to the third device, a request of the expected paging response related information. The request may comprise at least one of the number of packets to be transmitted, a reference cell identification, or an authentication information fetching request.

In some example embodiments, the request is sent via a control message, such as a S1 message.

At 440, if the second device determines that the paging response is valid, the second device may, at 450, perform the data transmission to the first device.

In some example embodiments, if a field included in the paging response received from the first device matches the expected paging response, the second device may determine that the paging response is valid.

In some example embodiments, if the validity timer has not expired, the second device may determine that the paging response is valid.

In some example embodiments, the second device may perform the data transmission via the MT-EDT procedure or a RRC connection.

In some example embodiments, the first device comprises a terminal device, the second device comprises a radio access network device and the third device comprises a core network device. The first device, the second device and the third device operate in the store and forward mode.

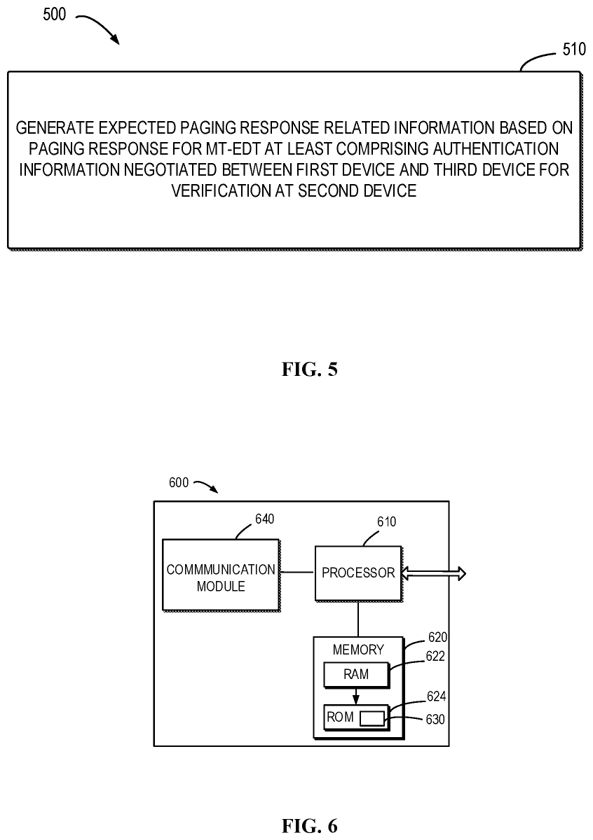

FIG. 5 shows a flowchart of an example method 500 of MT-EDT for IoT according to some example embodiments of the present disclosure. The method 500 may be implemented at the third device 130 as shown in FIG. 1. For the purpose of discussion, the method 500 will be described with reference to FIG. 1.

At 510, the third device 130 generates expected paging response related information based on a paging response for a mobile terminated early data transmission at least comprising authentication information negotiated between a first device and the third device for a verification at a second device.

In some example embodiments, the expected paging response related information may comprise at least one of a downlink NAS transport message, an expected paging response, a validity timer for a connectivity of the first device, or a validity timer for a lifetime of the expected paging response.

In some example embodiments, if the third device receives, from a second device, a request of the expected paging response related information, the third device may provide the expected paging response related information to the second device.

In some example embodiments, the request may comprise at least one of the number of packets to be transmitted, a reference cell identification, or an authentication information fetching request.

In some example embodiments, the third device may negotiate the paging response for the MT-EDT with the first device, the authentication information being included in the paging response.

In some example embodiments, the first device comprises a terminal device, the second device comprises a radio access network device and the third device comprises a core network device. The first device, the second device and the third device operate in the store and forward mode.

In some example embodiments, an apparatus capable of performing the method 300 (for example, implemented at the first device 110) may include means for performing the respective steps of the method 300. The means may be implemented in any suitable form. For example, the means may be implemented in a circuitry or software module.

In some example embodiments, the apparatus comprises means for, in response to detecting, from a second device, a paging for a MT-EDT, sending, to the second device, a paging response at least comprising authentication information negotiated between the first device and a third device for a verification at the second device; and means for receiving data transmission from the second device.

In some example embodiments, the apparatus further comprises means for negotiating the paging response for the MT-EDT with the third device, the authentication information being included in the paging response.

In some example embodiments, respective paging responses with different fields are negotiated between the first device and the third device for a plurality of successive mobile terminated early data transmissions, and wherein the different fields are used for the plurality of successive mobile terminated early data transmissions in order.

In some example embodiments, the means for sending the paging response comprises means for sending the paging response from the first device to the second device via an MSG 3 in a random access procedure or a RRC signaling.

In some example embodiments, the means for receiving the data transmission may comprise means for receiving the data transmission via the MT-EDT procedure or a RRC connection.

In some example embodiments, the first device comprises a terminal device, the second device comprises a radio access network device and the third device comprises a core network device. The first device, the second device and the third device operate in the store and forward mode.

In some example embodiments, an apparatus capable of performing the method 400 (for example, implemented at the second device 120) may include means for performing the respective steps of the method 400. The means may be implemented in any suitable form. For example, the means may be implemented in a circuitry or software module.

In some example embodiments, the apparatus comprises means for initiating a paging procedure for a MT-EDT; means for, in response to receiving, from a first device, a paging response at least comprising authentication information, verifying a validity of the paging response based on expected paging response related information for the MT-EDT received from a third device; and means for, in response to determining that the paging response is valid, performing the data transmission to the first device.

In some example embodiments, the means for verifying the validity of the paging response may comprises means for verifying the validity of the paging response for for an authentication of the first device.

In some example embodiments, the apparatus further comprises means for obtaining, from a third device, the expected paging response related information. The expected paging response related information may comprise at least one of a downlink NAS transport message, an expected paging response, a validity timer for a connectivity of the first device, or a validity timer for a lifetime of the expected paging response.

In some example embodiments, the expected paging response related information is obtained via a control message, such as a S1 message.

In some example embodiments, the apparatus further comprises means for sending, to the third device, a request of the expected paging response related information. The request may comprise at least one of the number of packets to be transmitted, a reference cell identification, or an authentication information fetching request.

In some example embodiments, the request is sent via a control message, such as a S1 message.

In some example embodiments, the apparatus further comprises means for, in response to that a field included in the paging response received from the first device matches the expected paging response, determining that the paging response is valid.

In some example embodiments, the apparatus further comprises means for, in response to that the validity timer has not expired, determining that the paging response is valid.

In some example embodiments, the means for performing the data transmission may comprise means for performing the data transmission via the MT-EDT procedure or a RRC connection.

In some example embodiments, the first device comprises a terminal device, the second device comprises a radio access network device and the third device comprises a core network device. The first device, the second device and the third device operate in the store and forward mode.

In some example embodiments, an apparatus capable of performing the method 500 (for example, implemented at the third device 130) may include means for performing the respective steps of the method 500. The means may be implemented in any suitable form. For example, the means may be implemented in a circuitry or software module.

In some example embodiments, the apparatus comprises means for generating expected paging response related information based on a paging response for a mobile terminated early data transmission at least comprising authentication information negotiated between a first device and the third device for a verification at a second device.

In some example embodiments, the expected paging response related information may comprise at least one of an expected paging response, a validity timer for a connectivity of the first device, or a validity timer for a lifetime of the expected paging response.

In some example embodiments, the means for providing the expected paging response related information comprises means for, in response to receiving, from a second device, a request of the expected paging response related information, providing the expected paging response related information to the second device.

In some example embodiments, the request may comprise at least one of the number of packets to be transmitted, a reference cell identification, or an authentication information fetching request.

In some example embodiments, the apparatus further comprises means for negotiating the paging response for the MT-EDT with the first device, the authentication information being included in the paging response.

In some example embodiments, the first device comprises a terminal device, the second device comprises a radio access network device and the third device comprises a core network device. The first device, the second device and the third device operate in the store and forward mode.

FIG. 6 is a simplified block diagram of a device 600 that is suitable for implementing example embodiments of the present disclosure. The device 600 may be provided to implement a communication device, for example, the UE 110, the RAN device 120 or the CN device 130 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

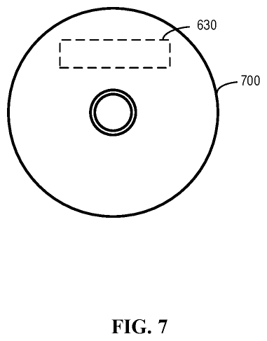

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory storing instructions that, when executed by the at least one processor, cause the first device at least to:
in response to detecting, from a second device, a paging for a mobile terminated early data transmission, send, to the second device, a paging response at least comprising authentication information negotiated between the first device and a third device for a verification at the second device; and
receive data transmission from the second device.

2. The first device of claim 1, wherein the first device is further caused to:
negotiate the paging response for the mobile terminated early data transmission with the third device, the authentication information being included in the paging response.

3. The first device of claim 1, wherein respective paging responses with different fields are negotiated between the first device and the third device for a plurality of successive mobile terminated early data transmissions, and wherein the different fields are used for the plurality of successive mobile terminated early data transmissions in order.

4. The first device of claim 1, wherein the first device is caused to:
receive the data transmission from the second device via the mobile terminated early data transmission or a radio resource control connection.

5. The first device of claim 1, wherein the paging response is sent from the first device to the second device via a message 3 in a random access procedure or a radio resource control signaling.

6. The first device of claim 1, wherein the first device comprises a terminal device, the second device comprises a radio access network device and the third device comprises a core network device, and wherein the terminal device, the radio access network device and the core network device operate in a store and forward mode.

7. A second device comprising:
at least one processor; and
at least one memory storing instructions that, when executed by the at least one processor, cause the second device at least to:
initiate a paging procedure for a mobile terminated early data transmission;
in response to receiving, from a first device, a paging response at least comprising authentication information, verify a validity of the paging response based on expected paging response related information for the mobile terminated early data transmission received from a third device; and
in response to determining that the paging response is valid, perform the data transmission to the first device.

8. The second device of claim 7, wherein the second device is further caused to:
verify the validity of the paging response for an authentication of the first device.

9. The second device of claim 7, wherein the second device is further caused to:
obtain, from a third device, the expected paging response related information, the expected paging response related information comprising at least one of the following:
a downlink non-access-stratum transport message,
an expected paging response, or
a validity timer for a connectivity of the first device, or
a validity timer for a lifetime of the expected paging response.

10. The second device of claim 9, wherein the expected paging response related information is obtained via a control message.

11. The second device of claim 9, wherein the second device is further caused to:
in response to that a field included in the paging response received from the first device matches the expected paging response, determine that the paging response is valid.

12. The second device of claim 9, wherein the second device is further caused to:
in response to that the validity timer has not expired, determine that the paging response is valid.

13. The second device of claim 7, wherein the second device is further caused to:
in accordance with a determination that an indication, that the first device is to be served by the second device, is received from the third device, send, to the third device, a request of the expected paging response related information, the request comprising at least one of the following:
the number of packets to be transmitted,
a reference cell identification, or
an authentication information fetching request.

14. The second device of claim 13, wherein the request is sent via a control message.

15. The second device of claim 7, wherein the second device is further caused to:
perform the data transmission via the mobile terminated early data transmission or a radio resource control connection.

16. The second device of claim 7, wherein the first device comprises a terminal device, the second device comprises a radio access network device and the third device comprises a core network device, and wherein the terminal device, the radio access network device and the core network device operate in a store and forward mode.

17. A third device comprising:
at least one processor; and
at least one memory storing instructions that, when executed by the at least one processor, cause the third device at least to:
generate expected paging response related information based on a paging response for a mobile terminated early data transmission at least comprising authentication information negotiated between a first device and the third device for a verification at a second device.

18. The third device of claim 17, wherein the expected paging response related information comprises at least one of the following:
a downlink non-access-stratum transport message,
an expected paging response, or
a validity timer for a connectivity of the first device, or
a validity timer for a lifetime of the expected paging response.

19. The third device of claim 17, wherein the third device is caused to:
in response to receiving, from a second device, a request of the expected paging response related information, provide the expected paging response related information to the second device.

20. The third device of claim 19, wherein the request of the expected paging response related information, the request comprising at least one of the following:
the number of packets to be transmitted,
a reference cell identification, or
an authentication information fetching request.

21.-29. (canceled)
